(19) United States
(12) Patent Application Publication
(10) Pub. No.: US 2012/0244321 A1
(43) Pub. Date: Sep. 27, 2012

(54) METHOD FOR MANUFACTURING A PRODUCT SHELL AND STRUCTURE

(75) Inventors: MU-CHI HSU, Tu-Cheng (TW); SHAO-MING FU, Tu-Cheng (TW)

(73) Assignee: HON HAI PRECISION INDUSTRY CO., LTD., Tu-Cheng (TW)

(21) Appl. No.: 13/279,284

(22) Filed: Oct. 23, 2011

(30) Foreign Application Priority Data
Mar. 25, 2011 (TW) 100110364

(51) Int. Cl. B32B 3/30; B05D 5/00; C08F 2/48; B05D 3/00

(52) U.S. Cl. 428/172; 427/331; 427/256; 427/508

(57) ABSTRACT

The disclosure provides a method for manufacturing a product shell. A diaphanous mold with a recess and a coating layer located inside the recess are provided. A substrate is disposed inside the recess. The coating layer is located between the recess and the substrate. The coating layer is cured to combine with the substrate by a curing device through the diaphanous mold. The substrate is then removed from the diaphanous mold to form the product shell.

### TECHNICAL FIELD

The disclosure relates generally to a method for manufacturing a product shell and structure, more particularly to a product shell with a coating layer and the method for manufacturing thereof.

### DESCRIPTION OF THE RELATED ART

Many shells of computer, communication, or consumer electronic products (3C) are manufactured by injection molding or other molding technologies, and composed of metal, plastic, or wood. Moreover, the shells may also be constructed with functional indexes, trademarks, or various patterns by molding, transfer printing, laser engraving, or surface machining. These shells may undergo another process to prevent damage or scratches during normal use. A protection layer on the shell can be formed via spray painting or coating electrostatic powder, but care is required to avoid uneven paint distribution or flow banding on the product shells. The protection layer can then be cured by natural air, heat, or UV light. The process is complex and expensive due to multiple processes, labor, raw material costs, and long processing times. Hence, it is necessary to provide a new method for manufacturing a product shell and the structure.

### BRIEF DESCRIPTION OF THE DRAWINGS

FIG. 1 is a flow chart of an embodiment of a method for manufacturing a product shell.

FIG. 2 is a schematic diagram showing an embodiment of a step of providing a diaphanous mold in accordance with the method of FIG. 1.

FIG. 3 is a schematic diagram showing an embodiment of a step of curing a coating layer to combine a coating layer with a substrate by a curing device in accordance with the method of FIG. 1.

FIG. 4 is a cross section of an embodiment of the product shell.

### DETAILED DESCRIPTION

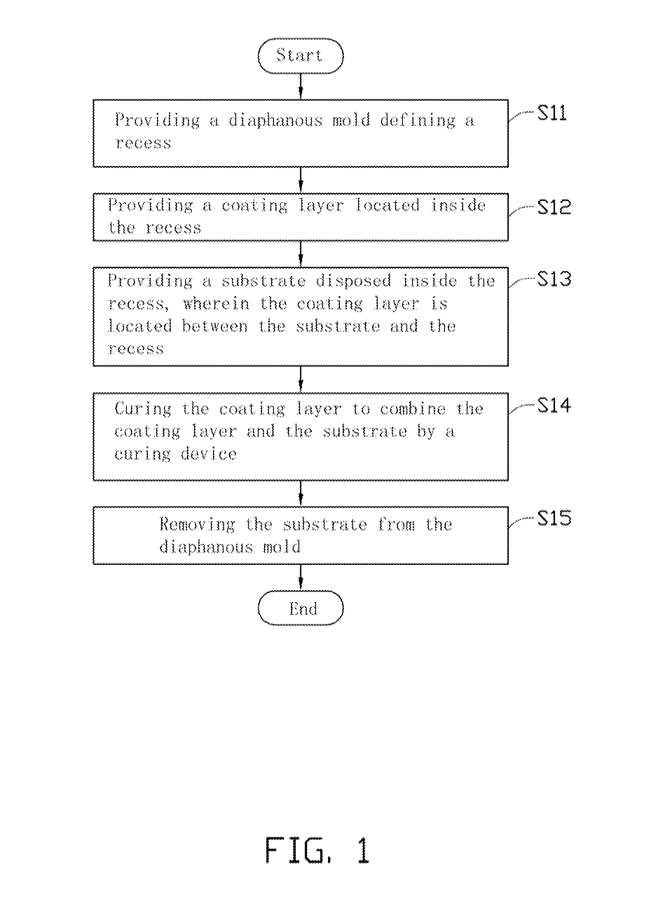

Referring to FIG. 1, one embodiment of a method for manufacturing a product shell includes the following steps.

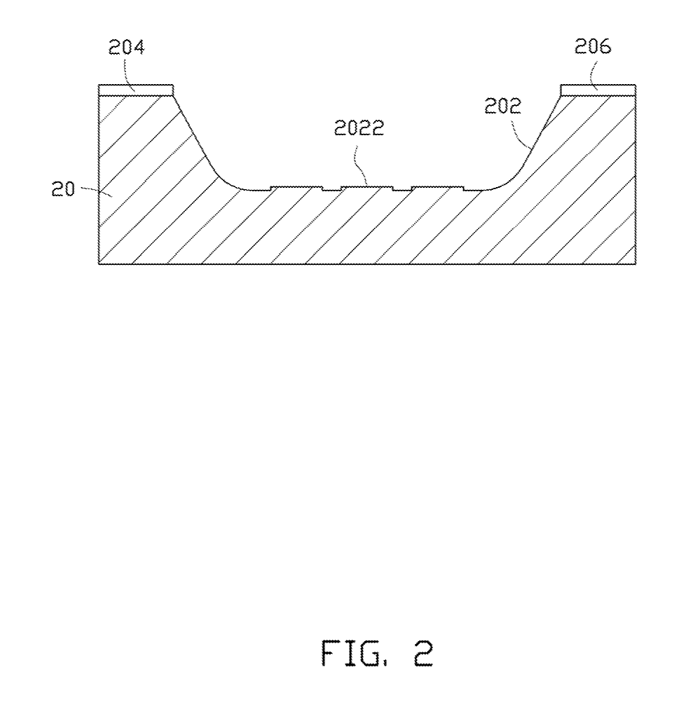

In step S11, a diaphanous mold 20 with a recess 202 is provided, as shown in FIG. 2. The diaphanous mold 20 further includes an injection port 204 and a discharging port 206 opposite to each other, wherein the injection port 204 and the discharging port 206 each communicate the diaphanous mold 20 from the recess 202 to the outside.

In one embodiment, the recess 202 includes a preformed pattern 2022 made by sandblasting, sintering, or 3D glass printing. In this embodiment, the 3D glass printing or glass embossing is achieved by 3D printing technology applied to glass, in which powdered glass and cement material are first mixed in a predetermined percentage. The mixture is then constructed into a desired 3D pattern through printing technology. Finally, the mixture is heated and melted to form the desired 3D pattern. In the embodiment, the preformed pattern 2022 is previously formed upon a surface of the recess 202 by 3D glass printing, wherein the diaphanous mold 20 is glass.

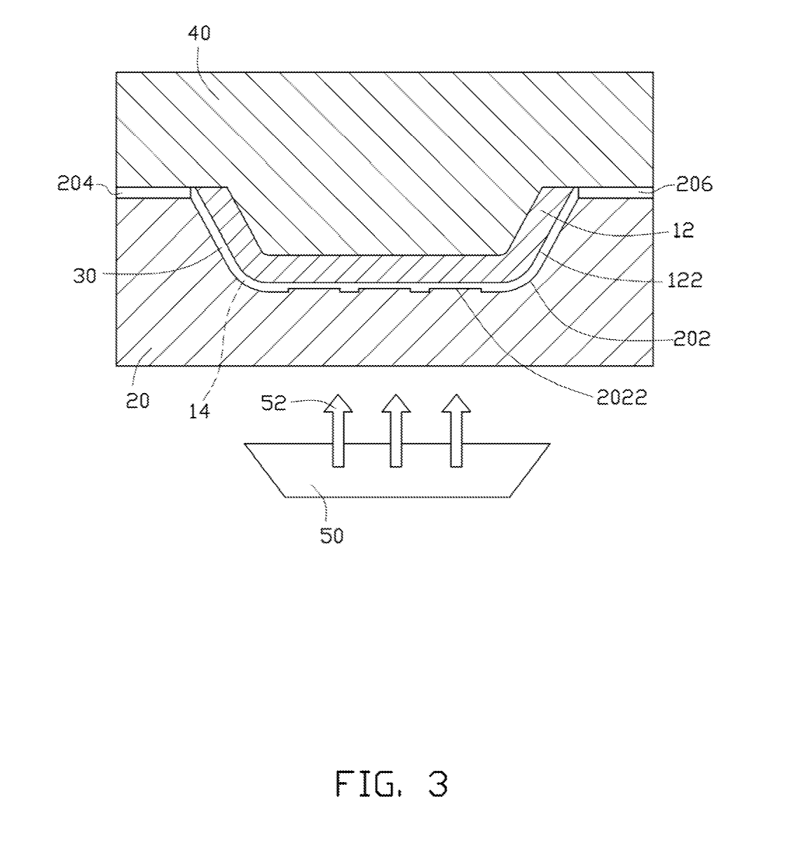

In step S12, a coating layer 14 located inside the recess 202 is provided, as shown in FIG. 3. In one embodiment, the coating layer 14 is a synthetic resin such as photo-curing resin and thermosetting resin. The photo-curing resin can be UV-curing resin or visible light-curing resin.

In step S13, a substrate 12 disposed inside the recess 202 is provided. The coating layer 14 is located between the recess 202 and the substrate 12, as shown in FIG. 3. The substrate 12 is received into the recess 202 and the surface 122 of the substrate 12 is adjacent to the recess 202. In one embodiment, a void 30 is defined between the diaphanous mold 20 and the substrate 12 as the substrate 12 is disposed inside the recess 202. The void 30 is configured for receiving the coating layer 14. The structure of the void 30 is determined by the recess 202 and the surface 122 of the substrate 12. In one embodiment, a thickness of the void 30 is substantially equal throughout. Moreover, the substrate 12 can include a supporting device 40 engaging an ambit (not labeled) of the diaphanous mold 20 to fix the position of the substrate 12. The supporting device 40 can be adjustable so that the position of the substrate 12 and the thickness of the void 30 can be modified. The substrate 12 can be aluminum, aluminum alloy, stainless steel, plastic, and wood.

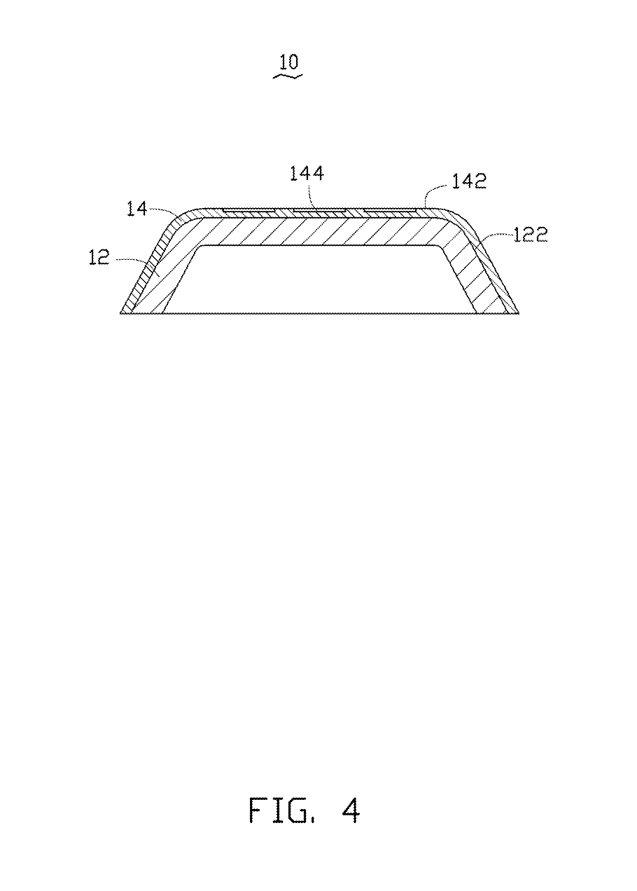

In one embodiment as shown in FIG. 3, before providing the coating layer 14 located inside the recess 202, the void 30 is allocated between the diaphanous mold 20 and the substrate 12 as the supporting device 40 engages with the diaphanous mold 20. The coating layer 14 can be a fluid material injected into the void 30 via the injecting port 204. Air filled inside the void 30 can exit through the discharging port 206. For integrally forming the coating layer 14, the void 30 and the recess 202 should not contain any bubbles or cracks which can be surveyed through the diaphanous mold 20. Since the fluid material is filled in the void 30, the preformed pattern 2022 is applied to an external surface 142 of the coating layer 14. The external surface 142 becomes a molding layer 144 and holds the preformed pattern 2022, as shown in FIG. 4. In one embodiment, the preformed pattern 2022 of the recess 202 is a 3D glass pattern, such that the molding layer 144 of the coating layer 14 contains such 3D pattern. Alternatively, in the other embodiment, the coating layer 14 is previously located inside the recess 202 before providing the substrate 12 disposed inside the recess 202. The substrate 12 is deposed inside the recess 202 engaging the supporting device 40 to the diaphanous mold 20 and the coating layer 14 is located on the surface 122 of the substrate 12.

In step S14, a curing device 50 cures the coating layer 14 to combine the substrate 12, as shown in FIG. 3. In this embodiment, the curing device 50 is located outside the diaphanous mold 20 and emits light from a light source 52 to the diaphanous mold 20. The diaphanous mold 20 is transparent, so that light emitted from the light source 52 can transmit through the diaphanous mold 20 and cure the coating layer 14 inside the diaphanous mold 20. Alternatively, the light source 52 can be UV, infrared, laser, or halogen light. In one embodiment, the light source 52 is UV light and the coating layer 14 is UV-curing resin.

In step S15, the substrate 12 is removed from the diaphanous mold 20, as shown in FIG. 3 and FIG. 4. After the curing device 50 cures the fluid material, the coating layer 14 combines with the substrate 12, such that when the substrate 12 is removed from the diaphanous mold 20 and removed from the supporting device 40, the coating layer 14 remains on the substrate 12.

Referring to FIG. 4, a product shell 10 includes a substrate 12 and a coating layer 14. The substrate 12 includes a surface 122, and the coating layer 14 is located on the surface 122. The coating layer 14 has an external surface 142 with a molding surface 144 having a complement of the preformed pattern 2022, which corresponds to the recess 202 of the diaphanous mold 20. The substrate 12 and the surface 122 can be composed of metal, plastic, or wood. Alternatively, the surface 122 can be an encapsulating layer made by coating, plating, or bonding, and may have various colors, trademarks, marks, or designed patterns. In the embodiment, the substrate 12 is metal such as aluminum, aluminum alloy, or stainless steel, and the coating layer 14 is UV-curing resin. The coating layer 14 protects the substrate 12, and the molding surface 144 is constructed for enhancing texture and practicable value of the product.

The process is very convenient and quick because the coating layer 14 made of photo-curing resin encapsulates the substrate 12 via the diaphanous mold 20, and is then cured by light directly traveling through the diaphanous mold 20. Moreover, the complement of the preformed pattern 2022 can be printed on the external surface 142 of the coating layer 14 to form a texture on the product shell 10.

It is to be understood, however, that even though multiple characteristics and advantages of the disclosure have been set forth in the foregoing description, together with details of the structure and function of the invention disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A method for manufacturing a product shell, the method comprising the following steps:
providing a diaphanous mold defining a recess;
providing a coating layer located inside the recess;
providing a substrate disposed inside the recess, wherein the coating layer is located between the diaphanous mold and the substrate;
curing the coating layer to combine the coating layer with the substrate by a curing device; and
removing the substrate from the diaphanous mold.

2. The method as claimed in claim 1, wherein the diaphanous mold further defines an injecting port and a discharging port opposite to each other.

3. The method as claimed in claim 2, wherein the injecting port and the discharging port both communicate the recess to the outside.

4. The method as claimed in claim 1, wherein the recess comprises a pre-formed pattern made by sandblasting, sintering or three dimensional (3D) glass printing.

5. The method as claimed in claim 4, wherein the pre-formed pattern is made by 3D glass printing on a surface of the recess, and the diaphanous mold is made of glass.

6. The method as claimed in claim 1, wherein a fluid material is injected into a void between the diaphanous mold and the substrate, to form the coating layer.

7. The method as claimed in claim 6, wherein a thickness of the void is substantially equal.

8. The method as claimed in claim 1, wherein the substrate further comprises a supporting device engaging with an ambit of the diaphanous mold to fix the location of the substrate.

9. The method as claimed in claim 8, wherein the supporting device is adjustable to adjust the size of the void.

10. The method as claimed in claim 1, wherein the substrate is selected from the group consisting of metal, plastic, and wood.

11. The method as claimed in claim 10, wherein the metal substrate is selected from the group consisting of aluminum, aluminum alloy, and stainless steel.

12. The method as claimed in claim 1, wherein the coating layer is made of synthetic resin selected from the group consisting of photo-curing resin and thermosetting resin.

13. The method as claimed in claim 12, wherein the photo-curing resin is UV-curing resin or visible light-curing resin.

14. The method as claimed in claim 1, wherein the curing device is located outside the diaphanous mold and provides a light source.

15. The method as claimed in claim 14, wherein the light source provides UV, infrared, laser, or halogen light.

16. The method as claimed in claim 1, wherein the coating layer is located inside the recess before the substrate is disposed in the recess.

17. A product shell, comprising a substrate and a coating layer, wherein the coating layer is located on a surface of the substrate and an external surface of the coating layer comprises a molding surface.

18. The product shell as claimed in claim 17, wherein the surface of the substrate is an encapsulating layer made by coating, plating, or bonding.

19. A product shell, comprising a substrate and a coating layer, wherein the coating layer is located on a surface of the substrate by molding technology, and the coating layer comprises an external surface having a 3D pattern.
